(19) United States
(12) Patent Application Publication
(10) Pub. No.: US 2004/0042386 A1
(43) Pub. Date: Mar. 4, 2004

(54) Data transmission apparatus and data transmission method

(76) Inventors: Mitsuru Uesugi, Yokosuka-shi (JP); Kazunori Inogai, Yokohama-shi (JP); Atsushi Sumasu, Yokosuka-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/381,696

(22) PCT Filed: Jul. 29, 2002
(86) PCT No.: PCT/JP02/07707

(30) Foreign Application Priority Data
Jul. 31, 2001 (JP) 2001-232928

(51) Int. Cl. H04L 5/04

(52) U.S. Cl. 370/204; 370/342

(57) ABSTRACT

An orthogonal variable spreading factor (OVSF) of one dimension represented by coding tree is extended into two dimensions and applied simultaneously in both directions, frequency axis direction and time axis direction when carrying out spreading of two dimensions of frequency axis direction and time axis direction. For example, the transmission data is first spread by OVSF code of one dimension in the frequency axis direction (obtained from frequency axis direction OVSF code assignment section 11), and the result is spread by OVSF code of one dimension in time axis direction (obtained from time axis direction OVSF code assignment section 13, which is selected independent of frequency axis direction) in each of two-dimensional spreading sections 1-1 to 1-8.

### TECHNICAL FIELD

The present invention relates to data transmission apparatus and data transmission method.

### BACKGROUND ART

Recently, a technique/method for transmission a high-speed data of different types such as image, voice, etc. in fields such as mobile communication or digital broadcasting etc. is considered extensively. Thus, the OFDM (Orthogonal Frequency Division Multiplexing) method and CDMA (Code Division Multiple Access) method which are combined together to perform OFDM-CDMA method recently attracts attention in the mobile communication field because of strong reason in frequency selective fading. The OFDM method is one measuring technique of frequency selective fading, further, it is one kind of multicarrier modulation method to achieve mutual orthogonality between a plurality of subcarriers (carrier waves), and there is a high-order modulation method which has the most frequency utilization efficiency among multicarrier modulation methods. In addition, the CDMA method similarly is one measuring technique of frequency selective fading, it is one kind of spectrum spreading communication method in which a signal is spread by spreading code, and it is a method in which a high resistance of interference is acquired by the spreading gain.

In such an OFDM-CDMA method, recently, executing a two-dimensional spreading of frequency axis direction and time axis direction in OFDM is proposed. Thus, when two-dimensional spreading is carried out in OFDM, the most suitable performance can be obtained by optimizing spreading factor of frequency axis direction and time axis direction based on channel situation.

FIG. 1 is a block diagram showing an exemplary configuration example of a data transmission apparatus and OFDM-CDMA method.

Such a data transmission apparatus comprising a plurality of two-dimensional spreading sections 1-1 to 1-8 to perform a two-dimensional spreading on the transmission data #1 to #8, a plurality of multiplexers (here two) 3-1 and 3-2 to multiplex the signal after being subjected to two-dimensional spreading, two point of Inverse Fast Frequency Transform (IFFT) section 5 to perform IFFT on the multiplexed signal outputted from each multiplexer, 3-1 and 3-2, and parallel to serial (P/S) converter 7 which outputs the transmission signal after converting the serial signal of two sequences outputted from IFFT section into parallel signal.

The two-dimensional spreading codes #1 to #8 which are used when the transmission data #1 to #8 are subjected to two-dimensional spreading in two-dimensional spreading sections 1-1 to 1-8 are obtained from orthogonal code assignment section 21. Here, the orthogonal codes of the same Spreading Factors (SF) are assigned for all transmission data #1 to #8 and each is multiplexed after being subjected to two-dimensional spreading. For example, let the spreading factor of frequency axis direction is SFf and spreading factor of time axis direction is SFt, in the example shown in FIG. 1, each of the transmission data #1 to #8 is spread 8 times per one symbol, that is, spread twice (SFf=2) in frequency axis direction, and spread 4 times (SFt=4) in time axis direction. At that time, all signals after two-dimensional spreading become orthogonal to each other. In this case, the spreading factor of frequency axis direction (SFf) and spreading factor of time axis direction (SFt) are of the same orthogonality state for all transmission data.

However, in the apparatus described above, when two-dimensional spreading is carried out in OFDM, although normal orthogonal code is used in executing spreading, there is a difficult problem to maintain the orthogonality between codes after performing multiplexing of signals of different spreading factors.

In other words, when two-dimensional spreading is carried out in OFDM, there is a difficult problem to maintain orthogonality between codes because there is a premise condition that both frequency axis direction and time axis direction are of similar spreading factor in the orthogonal signal after being multiplexed and subjected to a plurality of spreading even when a normal orthogonal code is used to carry out spreading under the condition that both/either of frequency axis direction and/or time axis direction of signals of different spreading factors are multiplexed. As the optimum value of spreading factor of frequency axis direction or spreading factor of time axis direction is different due to channel, the optimum value of each user is different because the channel of each user is different. In CDMA, because orthogonality of codes has large influence on the capacity, it is impossible to maintain the orthogonality of codes as the frequency axis direction and time-axis direction are not of the same spreading factor as described in the aforementioned apparatus even if orthogonality between codes is preserved when using different spreading factors among users.

### DISCLOSURE OF INVENTION

It is an object of the present invention to provide data transmission apparatus and data transmission method that can maintain orthogonality of codes even when spreading factors are different at the time of carrying out two-dimensional spreading of frequency axis direction and time axis direction, in addition, it is possible to optimize spreading factors of frequency axis direction and time axis direction of each code while maintaining orthogonality of codes.

To achieve the aforementioned object in the present invention, when carrying out a two-dimensional spreading of frequency axis direction and time axis direction in multicarrier modulation method of methods such as OFDM method, etc, by applying simultaneously the Orthogonal Variable Spreading Factor (OVSF) which is represented by a code tree of both directions, frequency axis direction and time axis direction, it is possible to multiplex a plurality of signals which maintain orthogonality between codes even when spreading codes are different.

### BRIEF DESCRIPTION OF DRAWINGS

FIG. 1 is a block diagram showing a configuration of a data transmission apparatus;

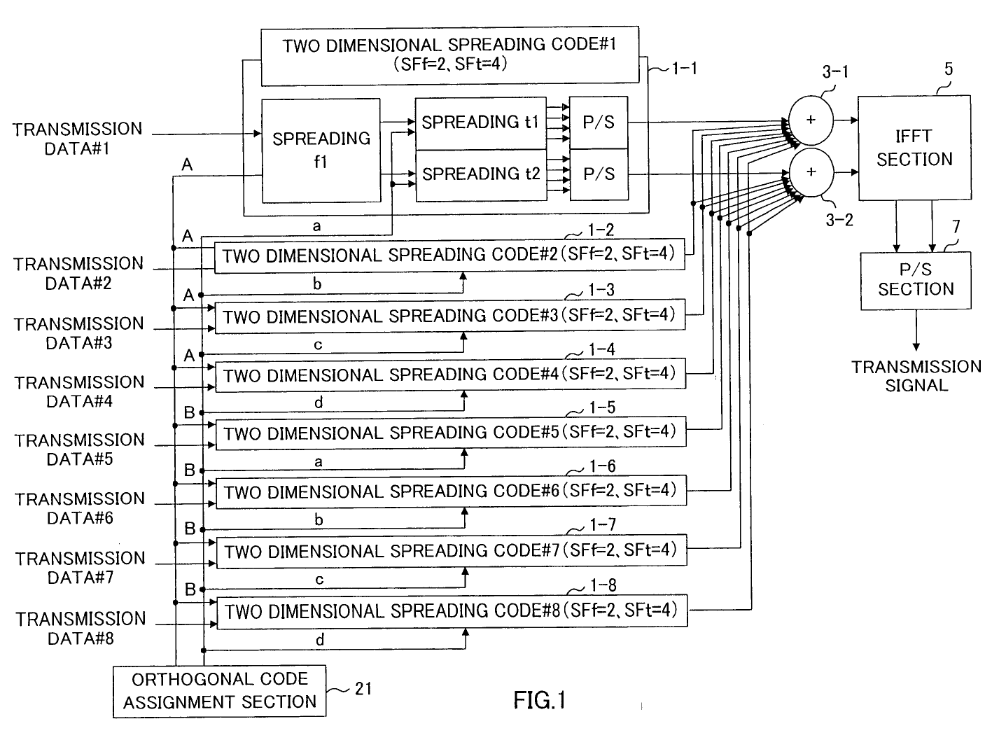

FIG. 2 is a block diagram showing a configuration of a data transmission apparatus according to one embodiment of the present invention;

FIG. 3 shows a chip allocation diagram of assignment example 1;

FIG. 4 is a diagram showing an example of a code pattern of assignment example 1;

FIG. 5 shows a chip allocation diagram of assignment example 2;

FIG. 6 is a diagram showing an example of a code pattern of assignment example 2;

FIG. 7 shows a chip allocation diagram of assignment example 3;

FIG. 8 is a diagram showing an example of a code pattern of assignment example 3;

FIG. 9 shows a chip allocation diagram of assignment example 4;

FIG. 10 is a diagram showing an example of a code pattern of assignment example 4;

FIG. 11 shows a chip allocation diagram of assignment example 5;

FIG. 12 is a diagram showing an example of a code pattern of assignment example 5.

### BEST MODE FOR CARRYING OUT THE INVENTION

Hereafter, embodiments of the present invention will be specifically described with reference to the accompanying drawings.

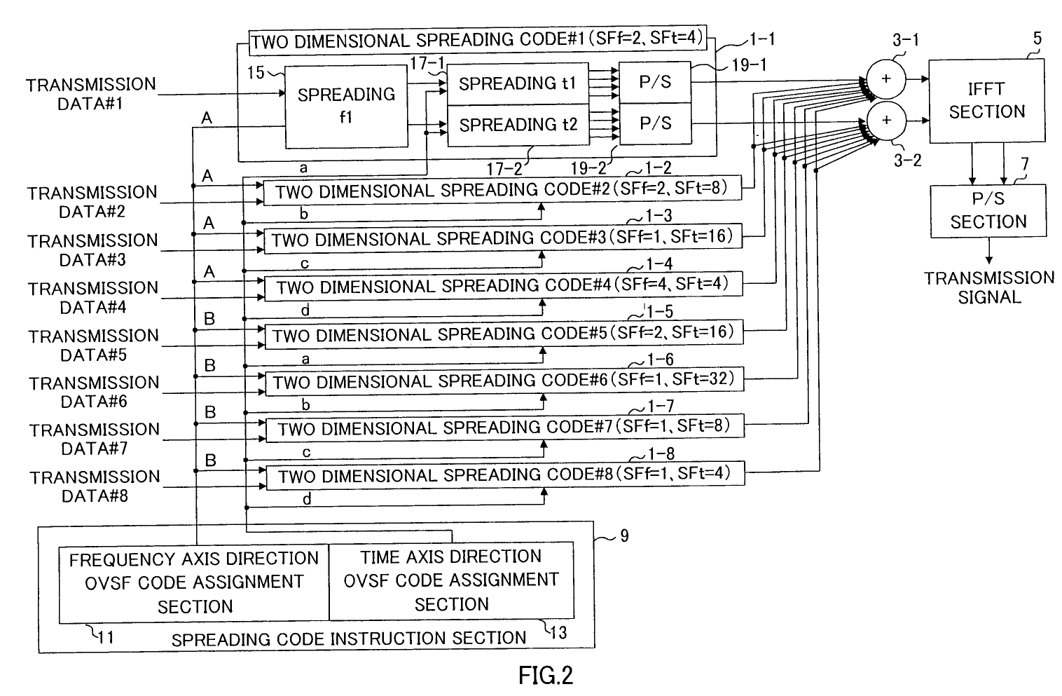

FIG. 2 is a block diagram showing a configuration of a data transmission apparatus according to one embodiment of the present invention. The data transmission apparatus shown in FIG. 2 is a data transmission apparatus of an OFDM-CDMA method, such a data transmission apparatus comprising a plurality of two-dimensional spreading sections 1-1 to 1-8 to perform two-dimensional spreading on the transmission data #1 to #8, a plurality of multiplexers (here two) 3-1 and 3-2 to multiplex the signal after being subjected to two-dimensional spreading, two point of Inverse Fast Frequency Transform (IFFT) section 5 to perform IFFT on the multiplexed signal outputted from each multiplexer, 3-1 and 3-2, and parallel to serial (P/S) converter 7 which outputs the transmission signal after converting the serial signal of two sequences outputted from IFFT section into parallel signal.

The spreading codes which are used when the transmission data #1 to #8 is subjected to two-dimensional spreading in two-dimensional spreading sections 1-1 to 1-8 are obtained from spreading code instruction section 9. Spreading code instruction section 9 comprising basically, Orthogonal Variable Spreading Factor (OVSF), that is, frequency axis direction OVSF code assignment section 11 which generates spreading code for frequency axis direction (first spreading code) and assigns the result to each two-dimensional spreading sections 1-1 to 1-8, also comprising Orthogonal Variable Spreading Factor (OVSF), that is, time axis direction OVSF code assignment section 13 which generates spreading code for time axis direction (second spreading code) and assigns the result to each of two-dimensional spreading section 1-1 to 1-8. Here, OVSF code is a spreading code used in CDMA, that is to say, spreading codes are mutually orthogonal (orthogonal codes) even if there are different spreading factors. A code (OVSF code) that satisfies the one-dimensional orthogonal variable spreading factor (OVSF) is already known and is used in Wideband-Code Division Multiple Access (W-CDMA) method which is a technology that multiplexes the codes of different spreading factors to keep the orthogonality. OVSF code can be derived using the coding tree. In particular, by combining of, for instance, an orthogonal code of a fixed spreading factor and another orthogonal code obtained from reversing the polarity of the orthogonal code, an orthogonal code of spreading factor which is larger than said spreading factor is generated. At that time, the code allocated under the same sequence is orthogonal regardless to layer (layer which is lowered by 1 and spreading code becomes double). Thus, orthogonal variable spreading factor (OVSF) of one dimension is extended into two dimensions.

Specifically, the transmission data is first spread by OVSF code of one-dimensional in frequency axis direction (obtained from frequency axis direction OVSF code assignment section 11), and the result is spread by OVSF code of one-dimensional in time axis direction (obtained from time axis direction OVSF code assignment section 13, which is selected independent of frequency axis direction) in each of two-dimensional spreading sections 1-1 to 1-8. Thus, transmission data is spread by two-dimensional orthogonal spreading code of SFf×SFt times (hereinafter, it is simply referred to as “two-dimensional spreading code”). It is to say that this two-dimensional spreading code is an OVSF code extended into 2 dimensions. As described above, SFf is the spreading factor of frequency axis direction, and SFt is the spreading factor of time axis direction. The values of SFt and SFf might be mutually different.

For example, the two-dimensional spreading code #1, as shown in the example of FIG. 2, is obtained in two-dimensional spreading section 1-1. The two-dimensional spreading code #1 is SFf=2 and SFt=4, and the total spreading factor (=SFf×SFt) is (=2×4).

Accordingly, with respect to transmission data #1 inputted in two-dimensional spreading section 1-1, first, the transmission data #1 is double spread (spread f1) in frequency axis direction by OVSF code of SFf=2 in frequency axis direction spreading section 15 which is inside two-dimensional spreading section 1-1, in addition, each chip after frequency axis direction spreading is 4 times spread (spread t1, spread t2) in time axis direction by OVSF code of SFt=4 in two time axis direction sections 17-1 and 17-2 which are corresponding to each chip after frequency axis direction spreading. The parallel signal outputted from each time axis direction spreading sections 17-1 and 17-2 is outputted to multiplexers 3-1 and 3-2 after being converted into serial signals in parallel to serial (P/S) converters 19-1 and 19-2 set according to each time axis direction spreading section 17-1 and 17-2.

Moreover, each of the two-dimensional spreading codes #2 to #8 of different spreading factors are obtained in two-dimensional spreading sections 1-2 to 1-8, as shown in the example of FIG. 2. For example, two-dimensional spreading code #2 obtained from two-dimensional spreading section 1-2 is SFf=2, SFt=8, and the total spreading factor is 16, two-dimensional spreading code #3 obtained from two-dimensional spreading section 1-3 is SFf=1, SFt=16, and the total spreading factor is 16, two-dimensional spreading code #4 obtained from two-dimensional spreading section 1-4 is SFf=4, SFt=4, and the total spreading factor is 16, two-dimensional spreading code #5 obtained from two-dimensional spreading section 1-5 is SFf=2, SFt=16, and the total spreading factor is 32, two-dimensional spreading code #6 obtained from two-dimensional spreading section 1-6 is SFf=1, SFt=32, and the total spreading factor is 32, two-dimensional spreading code #7 obtained from two-dimensional spreading section 1-7 is SFf=1, SFt=8, and the total spreading factor is 8, two-dimensional spreading code #8 obtained from two-dimensional spreading section 1-8 is SFf=1, SFt=4, and the total spreading factor is 4.

In addition, although spreading in time axis direction is made after spreading in frequency axis direction according to the present embodiment, but this is not limited to this. The order of spreading of frequency axis direction and spreading of time axis direction might be reversed.

Moreover, although different spreading factors are used in each two-dimensional spreading section 1-1 to 1-8 according to the present embodiment, but this is not limited to this and, of course, same spreading factors can be used.

Furthermore, although the case when multiplexing 8 transmission data #1 to #8 is explained as an example according to the present embodiment, but, of course, the multiplexing number of transmission data is not limited to this number.

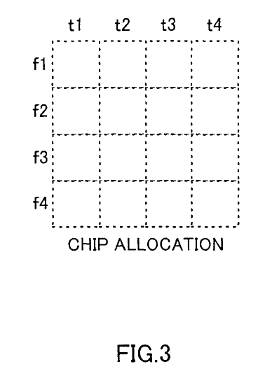

Next, assignment of two-dimensional spreading code will be explained specifically with reference to FIG. 3 to FIG. 12.

### ASSIGNMENT EXAMPLE 1

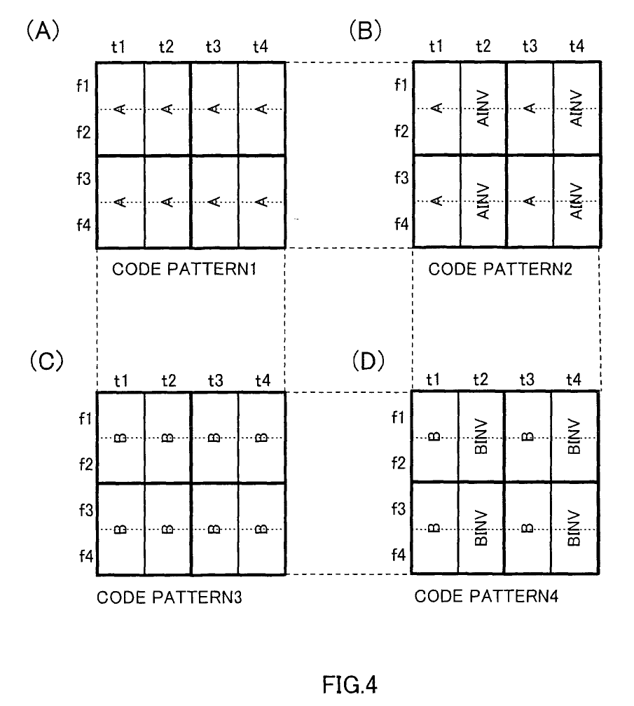

First, assignment example 1 is the case of assigning two-dimensional spreading code in which the spreading factors of frequency axis direction are similar and spreading factors of time axis direction are also similar. Here, four code patterns 1 to 4 shown in FIG. 4 are formed as a chip allocation diagram shown in FIG. 3 (4 chips in frequency axis, and 4 chips in time axis).

FIG. 4 is an example of total spreading factor=4, and it is an example of allocating two symbols one by one to each of two-dimensional spreading codes and which used four kinds of two-dimensional spreading code of SFf=2 and SFt=2 in a total of 8 chips, frequency axis direction 4 chips and time axis direction 2 chips. Here, the orthogonal codes A and B of two chips which are mutually orthogonal with spreading code of double of the spreading code of frequency axis direction are considered as basic codes. Both, A which is repeated two times chip code (hereinafter, it is shown as “A+A”), or A and A which is an inverse code (hereinafter, it is shown as “AINV”) are codes of 4 arranged chips (hereinafter, it is shown as “A+AINV) is a special code which is mutually orthogonal, both/each are orthogonal to B which is repeated two times chip code (hereinafter, it is shown as “B+B”), or B and B which is an inverse code (hereinafter, it is shown as “BINV”) are codes of 4 arranged chips (hereinafter, it is shown as “B+BINV). A+A corresponds to code pattern 1, A+AINV corresponds to code pattern 2, B+B corresponds to code pattern 3, and B+BINV corresponds to code pattern 4. Therefore, code patterns 1 to 4 shown in FIG. 4 each had given a different two-dimensional spreading code, and each had an 8 chips, in addition, it is possible to perform 2 symbols transmission with one of two-dimensional spreading code. Moreover, in FIG. 4(A) to FIG. 4(D), the thick solid line is the symbol portion, thin solid line is the basic code portion, and the dashed line is the chip portion.

Thus, according to the present example, since spreading factor of frequency axis direction and spreading factor of time axis direction using similar two-dimensional spreading code, all one-symbol ranges are also similar, and the total spreading factor (=SFf×SFt) is also the same, thus, it is possible to obtain the same multiplexing number. For example, in the example of FIG. 4, the total spreading factor is 4, and it is possible to multiplex 4 signals using 4 code patterns 1 to 4.

Next is the case when it is possible to maintain orthogonality between spreading codes and different total spreading factors.

### ASSIGNMENT EXAMPLE 2

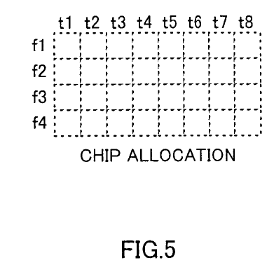

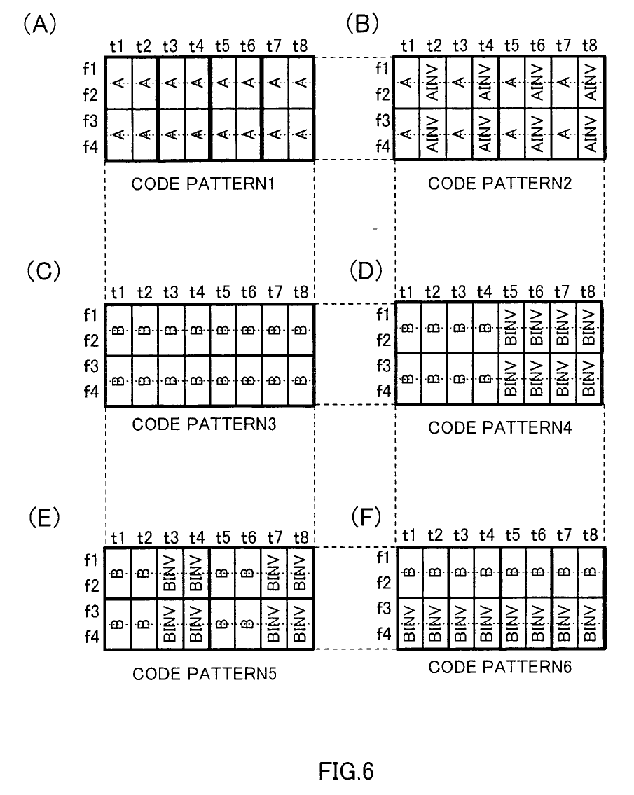

First, assignment example 2 of different total spreading factors is the case of assigning two-dimensional spreading code in which spreading factors of frequency axis direction are similar and spreading factors of time axis direction are different. Here, 6 code patterns 1 to 6 shown in FIG. 6 are formed as a chip allocation diagram shown in FIG. 5 (4 chips in frequency axis, and 8 chips in time axis).

The code patterns 1 to 6 shown in FIG. 6(A) to FIG. 6(F) represent the case where spreading factors of frequency axis directions are common to all (SFf=4), and spreading factors of time axis directions are 2, 4, 8, 8, 4, and 2 (SFt=2, 4, 8, 8, 4, 2), respectively. Here, orthogonal codes A and B of 2 chips which are mutually orthogonal with a spreading code of twice of the spreading code corresponds to frequency axis direction are considered as basic codes similar to the case of assignment example 1. Two-dimensional spreading code corresponds to code pattern 1 is SFf=4, SFt=2, and total spreading factor=8, obtained only from basic code A, two-dimensional spreading code corresponds to code pattern 2 is SFf=4, SFt=4, and total spreading factor=16, obtained from basic code A and the inverse of A code AINV, two-dimensional spreading code corresponds to code pattern 3 is SFf=4, SFt=8, and total spreading factor=32, obtained only from basic code B, two-dimensional spreading code corresponds to code pattern 5 is SFf=4, SFt=4, and total spreading factor=16, obtained from basic code B and the inverse of B code BINV, two-dimensional spreading code corresponds to code pattern 6 is SFf=4, SFt=2, and total spreading factor=8, obtained from basic code B and the inverse of B code BINV. Here, in FIG. 6(A) to FIG. 6(F), the thick solid line is the symbol portion, thin solid line is the basic code portion, and the dashed line is the chip portion. At this time, the symbol portion of the time axis direction in two-dimensional spreading code of which spreading factor of time axis direction is maximum, matches the symbol portions of time axis directions in all other two dimensional spreading code. For example, the symbol portion of time axis direction in code pattern 3 and code pattern 4 matches the symbol portion of time axis direction in other code pattern 1, code pattern 2, code pattern 5, and code pattern 6, where the spreading factor of time axis direction is maximum (SFt=8), as shown in FIG. 6. In OVSF, each code pattern 1 to 6 of two dimensional spreading code performed as described above are mutually orthogonal.

Moreover, in such a case, the orthogonal code shown in code patterns 1 to 6 is just a simple illustration, and there are other actual code patterns.

According to the present example, when spreading factors of frequency axis direction are similar and spreading factors of time axis direction are different in only multiple-integer in two-dimensional spreading code, to match the symbol portion of time axis direction of two-dimensional spreading code of which spreading factor of time axis direction is maximum with the symbol portions of time axis directions of all other two-dimensional spreading code, it is possible to maintain orthogonality of codes using OVSF even when only the spreading factor of time axis direction is different among the spreading factor of frequency axis direction and spreading factor of time axis direction.

### ASSIGNMENT EXAMPLE 3

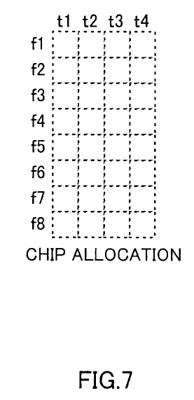

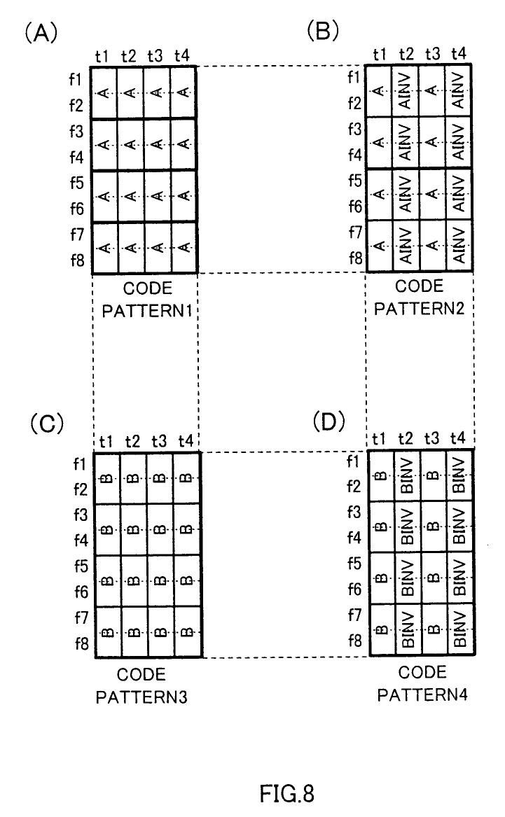

First, assignment example 3 of different total spreading factors is the case of assigning two-dimensional spreading code in which the spreading factors of time axis direction are similar and spreading factors of frequency axis direction are different. Here, four code patterns 1 to 4 shown in FIG. 8 are formed as a chip allocation diagram shown in FIG. 7 (8 chips in frequency axis, and 4 chips in time axis).

The code patterns 1 to 4 shown in FIG. 8(A) to FIG. 8(D) represent the case where spreading factors of time axis directions are common to all (SFt=4), and spreading factors of frequency axis directions are 2, 4, 8, and 8 (SFt=2, 4, 8, 8), respectively. Here, orthogonal codes A and B of 2 chips which are mutually orthogonal with a spreading code of twice of the spreading code corresponds to frequency axis direction are considered as basic codes similar to the case of assignment example 1. Two-dimensional spreading code corresponds to code pattern 1 is SFf=2, SFt=4, and total spreading factor=8, only obtained from basic code A, two-dimensional spreading code corresponds to code pattern 2 is SFf=4, SFt=4, and total spreading factor=16, obtained from basic code A and the inverse of A code AINV, two-dimensional spreading code corresponds to code pattern 3 is SFf=8, SFt=4, and total spreading factor=32, obtained only from basic code B, two-dimensional spreading code corresponds to code pattern 4 is SFf=8, SFt=4, and total spreading factor=32, obtained from basic code B and the inverse of B code BINV. Moreover, in FIG. 8(A) to FIG. 8(D), the thick solid line is the symbol portion, thin solid line is the basic code portion, and the dashed line is the chip portion. At this time, the symbol portion of frequency axis direction in two-dimensional spreading code of which spreading factor of frequency axis direction is maximum, matches the symbol portions of frequency axis directions in all other two-dimensional spreading code. For example, the symbol portion of frequency axis direction in code pattern 3 and code pattern 4 matches the symbol portion of frequency axis direction in other code pattern 1, and code pattern 2, where the spreading factor of frequency axis direction is maximum (SFf=8), as shown in FIG. 8. In OVSF, each code pattern 1 to 4 of two-dimensional spreading code performed as described above are mutually orthogonal.

Moreover, in such a case, the orthogonal code shown in code patterns 1 to 4 is just a simple illustration, and there are other actual code patterns.

According to the present example, when spreading factors of time axis direction are similar and spreading factors of frequency axis direction are different in only multiple-integer, to match the symbol portion of frequency axis direction in two-dimensional spreading code of which spreading factor of frequency axis direction is maximum with the symbol portions of frequency axis directions in all other two-dimensional spreading code, it is possible to maintain orthogonality of codes using OVSF even in the case when only the spreading factor of frequency axis direction is different among spreading factor of frequency axis direction and spreading factor of time axis direction.

### ASSIGNMENT EXAMPLE 4

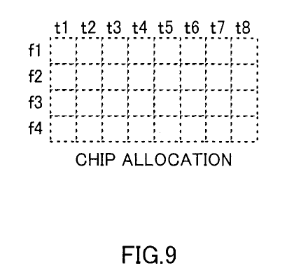

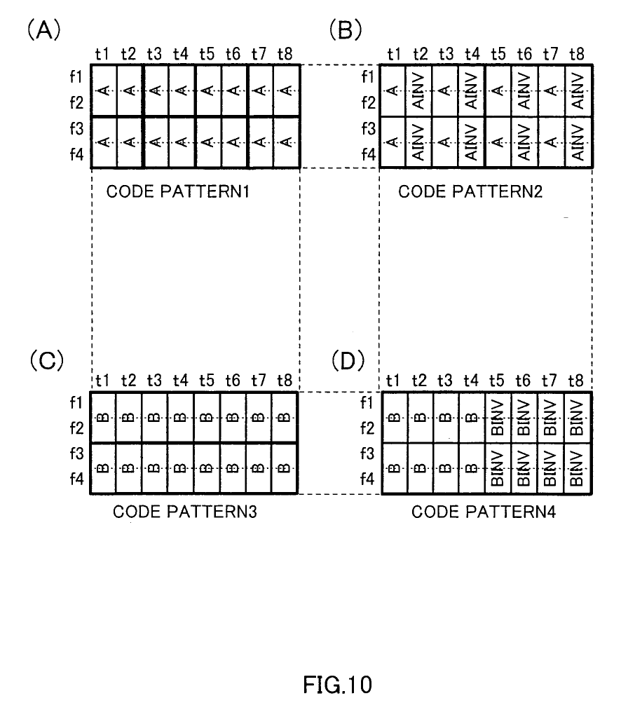

Next, assignment example 4 of different total spreading factor is the case of assigning two-dimensional spreading code in which the spreading factors of frequency axis direction and spreading factors of time axis direction are different. Here, four code patterns 1 to 4 shown in FIG. 10 are formed as a chip allocation diagram shown in FIG. 9 (4 chips in frequency axis, and 8 chips in time axis).

The code patterns 1 to 4 shown in FIG. 10(A) to FIG. 10(D) represent the case where spreading factors of frequency axis directions are 2, 4, 2, and 4 (SFf=2, 4, 2, 4), and spreading factors of time axis directions are 2, 4, 8, and 8 (SFt=2, 4, 8, 8), respectively. Here, orthogonal codes A and B of 2 chips which are mutually orthogonal to spreading code of twice of spreading code corresponds to frequency axis direction are considered as basic codes similar to the case of assignment example 1. Two-dimensional spreading code corresponds to code pattern 1 is SFf=2, SFt=2, and total spreading factor=4, obtained only from basic code A, two-dimensional spreading code corresponds to code pattern 2 is SFf=4, SFt=4, and total spreading factor=16, obtained from basic code A and the inverse of A code AINV, two-dimensional spreading code corresponds to code pattern 3 is SFf=2, SFt=8, and total spreading factor=16, obtained only from basic code B, two-dimensional spreading code corresponds to code pattern 4 is SFf=4, SFt=8, and total spreading factor=32, obtained from basic code B and the inverse of B code BINV. Moreover, in FIG. 10(A) to FIG. 10(D), the thick solid line is the symbol portion, thin solid line is the basic code portion, and the dashed line is the chip portion. At this time, the symbol portion of frequency axis direction in two-dimensional spreading code of which spreading factor of frequency axis direction is maximum, matches the symbol portions of frequency axis directions in all other two-dimensional spreading code, and the symbol portion of time axis direction in two-dimensional spreading code of which spreading factor of time axis direction is maximum, matches the symbol portions of time axis directions in all other two-dimensional spreading code. For example, the symbol portion of frequency axis direction in code pattern 2 and code pattern 4 matches the symbol portion of frequency axis direction in other code pattern 1 and code pattern 3, where spreading factor of frequency axis direction is maximum (SFf=4), as shown in FIG. 10, and the symbol portion of time axis direction in code pattern 3 and code pattern 4 matches the symbol portion of time axis direction in other code pattern 1 and pattern 2 where spreading factor of time axis direction is maximum (SFt=8), as shown in FIG. 10. In OVSF, each code pattern 1-4 of two-dimensional spreading code performed as described above are mutually orthogonal.

Moreover, in such a case, orthogonal code shown in code patterns 1 to 4 is just a simple illustration, and there are other actual code patterns.

According to the present example, when spreading factors of frequency axis direction are different in only multiple-integer and spreading factors of time axis direction are different in only multiple-integer and different two-dimensional spreading code, the symbol portion of frequency axis direction in two-dimensional spreading code of which spreading factor of frequency axis direction is maximum, matches the symbol portions of frequency axis directions in all other two-dimensional spreading code, and to match the symbol portion of time axis direction in two-dimensional spreading code of which spreading factor of time axis direction is maximum with the symbol portions of time axis directions in all other two-dimensional spreading code, it is possible to maintain orthogonality of codes using OVSF even when both spreading factors of frequency axis direction and time axis direction are different and when the total spreading factors are different.

### ASSIGNMENT EXAMPLE 5

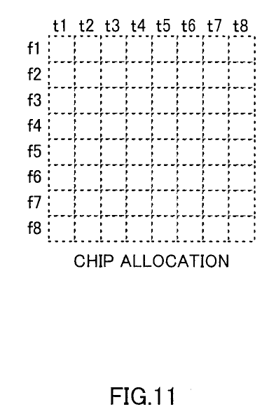

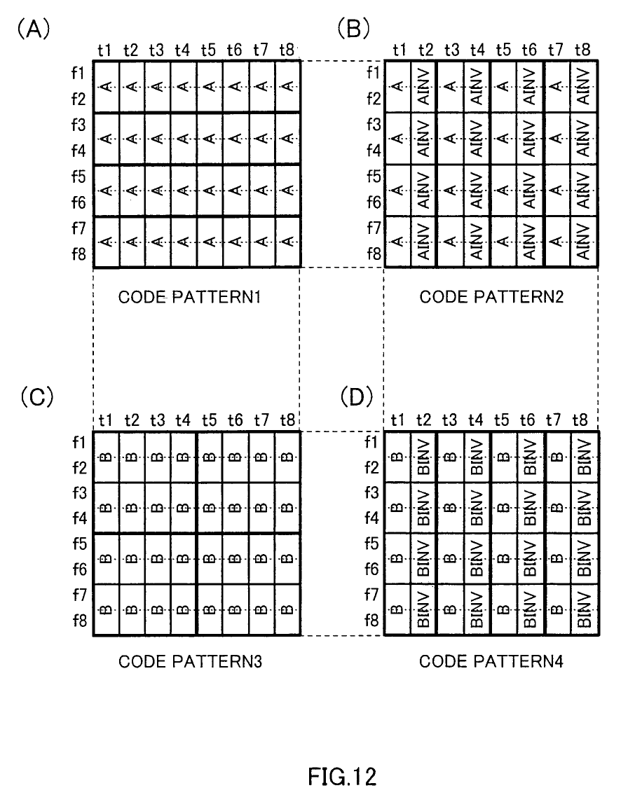

Assignment example 5 of fixed total spreading factors is the case of assigning two-dimensional spreading code in which the spreading factor of frequency axis direction and spreading factor of time axis direction are different. Here, four code patterns 1 to 4 shown in FIG. 12 are formed as a chip allocation diagram shown in FIG. 11 (8 chips in frequency axis, and 8 chips in time axis).

The code patterns 1 to 4 shown in FIG. 12(A) to FIG. 12(D) represent the case where the total spreading factor is fixed and equals 16, spreading factors of frequency axis directions are 2, 8, 4, and 8 (SFf=2, 8, 4, 8), and spreading factors of time axis directions are 8, 2, 4, and 2 (SFt=8, 2, 4, 2), respectively. Here, orthogonal codes A and B of 2 chips which are mutually orthogonal with spreading code of twice of the spreading code corresponds to frequency axis direction are considered as basic codes similar to the case of assignment example 1. Two-dimensional spreading code corresponds to code pattern 1 is SFf=2, SFt=8, and total spreading factor=16, obtained only from basic code A, two-dimensional spreading code corresponds to code pattern 2 is SFf=8, SFt=2, and total spreading factor=16, obtained from basic code A and the inverse of A code AINV, two-dimensional spreading code corresponds to code pattern 3 is SFf=4, SFt=4, and total spreading factor=16, obtained only from basic code B, two-dimensional spreading code corresponds to code pattern 4 is SFf=8, SFt=2, and total spreading factor=16, obtained from basic code B and the inverse of B code BINV. Moreover, in FIG. 12(A) to FIG. 12(D), the thick solid line is the symbol portion, thin solid line is the basic code portion, and the dashed line is the chip portion. At this time, the symbol portion of frequency axis direction in two-dimensional spreading code of which spreading factor of frequency axis direction is maximum, matches the symbol portions of frequency axis directions in all other two-dimensional spreading code, and the symbol portion of time axis direction in two-dimensional spreading code of which spreading factor of time axis direction is maximum, matches the symbol portions of time axis directions in all other two-dimensional spreading code. For example, the symbol portion of frequency axis direction in code pattern 2 and code pattern 4 matches the symbol portion of frequency axis direction in other code pattern 1 and pattern 3 where spreading factor of frequency axis direction is maximum (SFf=8), as shown in FIG. 12, and the symbol portion of time axis direction in code pattern 1 matches the symbol portion of time axis direction in other code pattern 2, code pattern 3, and code pattern 4 where the spreading factor of time axis direction is maximum (SFt=8), as shown in FIG. 12. In OVSF, each code pattern 1 to 4 of two-dimensional spreading code performed as described above are mutually orthogonal.

Moreover, in such a case, the orthogonal code shown in code patterns 1 to 4 is just a simple illustration, and there are other actual code patterns.

According to the present example, when spreading factors of frequency axis direction are different in only multiple-integer, and spreading factors of time axis direction are different in only multiple-integer as well the total spreading factor is fixed employed as different in multiple-integer two-dimensional spreading code, the symbol portion of frequency axis direction in two-dimensional spreading code of which spreading factor of frequency axis direction is maximum, matches the symbol portions of frequency axis directions in all other two-dimensional spreading code, and to match the symbol portion of time axis direction in two-dimensional spreading code of which spreading factor of time axis direction is maximum with the symbol portions of time axis directions in all other two dimensional spreading code, it is possible to maintain orthogonality of codes using OVSF even when spreading factor of frequency axis direction and spreading factor of time axis direction are different and when total spreading factors are the same.

Spreading code instruction section 9 selects two-dimensional spreading code obtained from each two-dimensional spreading sections 1-1 to 1-8 according to propagation situation. For example, the spreading factor of frequency axis direction (SFf) selects large two-dimensional spreading code, so that correlation characteristic of frequency axis direction becomes small, as there is a remarkable fear reduced orthogonality of frequency axis direction when there is a long delay wave, on the other hand, the spreading factor of time axis direction (SFt) selects large two-dimensional spreading code, so that correlation characteristic of time axis direction becomes small, as there is a remarkable fear reduced orthogonality of time axis direction under intensive time fluctuation. Even if the transmission rates of symbols are similar in two-dimensional OVSF, as described above, it is possible to freely change the ratio of spreading factor of frequency axis direction and spreading factor of time axis direction with spreading factor of time axis direction and spreading factor of frequency axis direction to maintain orthogonality of codes, it is also possible to freely maintain the ratio between both optimum spreading factor of frequency axis direction and spreading factor of time axis direction and maintaining the transmission rate of symbols of every code (i.e. every user) based on the channel situation and spreading factor of frequency axis direction and time axis direction of every code can be optimized while maintaining orthogonality of the code.

Thus, according to the data transmission apparatus of the present embodiment, it is possible to maintain orthogonality of codes even when spreading factors are different to perform two-dimensional spreading of frequency axis direction and time axis direction by two-dimensional OVSF, and it is also possible to multiplex a plurality of user signals as OFDM-CDMA signal subjected to two-dimensional spreading, therefore, the spreading factor of frequency axis direction and time axis direction can be optimized for every code (user) while maintaining orthogonality of the codes.

In addition, the data transmission apparatus according to the present embodiment, for instance, it is possible to built in both or either of base station apparatus and mobile station apparatus to compose a particular mobile communication system.

In accordance to the aforementioned present invention, it is possible to maintain orthogonality of codes even in when spreading factors are different and the two-dimensional spreading of frequency axis direction and time axis direction is carried out, in addition, it is possible to optimize the spreading factor of frequency axis direction and time axis direction of each code while maintaining orthogonality of codes.

The present application is based on the Japanese Patent Application No. 2001-232928 filed on Jul. 31, 2001, entire content of which is expressly incorporated by reference herein.

1. A data transmission apparatus that performs transmission of data by combining multicarrier modulation method and CDMA method, wherein said data transmission apparatus comprising:
spreading section that spreads simultaneously a plurality of transmission data in both directions, frequency axis direction and time axis direction using two dimensional orthogonal spreading code which composed of orthogonal variable spreading factor of frequency axis direction and orthogonal variable spreading factor of time axis direction; and
multiplexer that multiplexes said a plurality of transmission data after being spread.

2. The data transmission apparatus according to claim 1 further comprising:
first generator that generates first spreading code that is used in frequency axis direction in orthogonal variable spreading factor; and
second generator that generates second spreading code that is used in time axis direction in orthogonal variable spreading factor,
wherein said spreading section performs simultaneously spreading processing on both frequency axis direction and time axis direction used in first spreading code generated by said first generator and second spreading code generated by said second generator.

3. The data transmission apparatus according to claim 1, wherein said two dimensional orthogonal spreading code of which the spreading factors of frequency axis direction are similar, and the spreading factors of time axis direction are also similar during said a plurality of transmission data.

4. The data transmission apparatus according to claim 1, wherein
said two dimensional orthogonal spreading code of which the spreading factors of frequency axis direction are similar, and the spreading factors of time axis direction are different only in multiple integer; and
the symbol portion of time-axis direction in two dimensional orthogonal spreading code of which spreading factor of the time-axis direction is maximum matches the symbol portions of the time-axis directions in all other two dimensional orthogonal spreading code.

5. The data transmission apparatus according to claim 1, wherein
said two dimensional orthogonal spreading code of which the spreading factors of time axis direction are similar, and spreading factors of frequency axis direction are different only in multiple integer; and
the symbol portion of frequency-axis direction in the two dimensional orthogonal spreading code of which spreading factor of the frequency-axis direction is maximum matches the symbol portions of the frequency-axis directions in all other two dimensional orthogonal spreading code.

6. The data transmission apparatus according to claim 1, wherein
said two dimensional orthogonal spreading code of which the spreading factors of frequency axis direction are different in only multiple integer, and spreading factors of time axis direction are also different only in multiple integer; and
the symbol portion of frequency axis direction in the two dimensional orthogonal spreading code of which spreading factor of the frequency axis direction is maximum matches the symbol portions of the frequency axis directions in all other two dimensional orthogonal spreading code, in addition, the symbol portion of time axis direction in two dimensional orthogonal spreading code of which spreading factor of the time axis direction is maximum matches the symbol portions of the time axis directions in all other two dimensional orthogonal spreading code.

7. The data transmission apparatus according to claim 1, wherein
said two dimensional orthogonal spreading code of which has fixed total spreading factor is obtained by multiplying spreading factor of frequency axis direction with spreading factor of time axis direction; and
the symbol portion of frequency axis direction in two dimensional orthogonal spreading code of which spreading factor of the frequency-axis direction is maximum matches the symbol portions of the frequency axis directions in all other two dimensional orthogonal spreading code, in addition, the symbol portion of time axis direction in two dimensional orthogonal spreading code of which spreading factor of the time axis direction is maximum matches the symbol portions of the time axis directions in all other two dimensional orthogonal spreading code.

8. The data transmission apparatus according to claim 1, wherein said two dimensional orthogonal spreading code of which the spreading factor of frequency axis direction and the spreading factor of time axis direction can be changed based on propagation condition.

9. A data transmission method to perform transmission of data by combining multicarrier modulation method and CDMA method, wherein said data transmission method comprising:
spreading step of spreading simultaneously a plurality of transmission data in both directions, frequency axis direction and time axis direction using two dimensional orthogonal spreading code which composed of orthogonal variable spreading factor of frequency axis direction and orthogonal variable spreading factor of time axis direction; and
multiplexing step of multiplexing said a plurality of transmission data after being spread.
